(19) United States
(12) Patent Application Publication
(10) Pub. No.: US 2003/0150392 A1
(43) Pub. Date: Aug. 14, 2003

(54) Milk feeding of young animals

(76) Inventor: Helen Sundborger, Uppsala (SE)

Correspondence Address: HARNESS, DICKEY & PIERCE, P.L.C., P.O. BOX 8910, RESTON, VA, 20195, US

(21) Appl. No.: 10/240,594

(22) PCT Filed: Mar. 20, 2001
(86) PCT No.: PCT/SE01/00573

(51) Int. Cl. A01K 9/00

(52) U.S. Cl. 119/71

(57) ABSTRACT

The present invention refers to a feed apparatus for automatic milk feeding of young animals comprising a feed supply device (6, 6b, 43) comprising a milk line (23, 23b, 23c) connectable to said feed supply device and further connectable to a milking machine (14) arranged for milking of a plurality of animals, wherein said milk line is adapted to automatically transport milk from at least a selected one of said plurality of milk producing animals to said feed supply device. The invention relates further to an arrangement comprising the feed device and to a method for milk feeding of young animals.

### TECHNICAL FIELD OF THE INVENTION

The present invention generally relates to dairy farming and to milk handling therein.

Particularly, the invention relates to a feed device, an arrangement and a method for automatic milk feeding of young animals.

### DESCRIPTION OF RELATED ART AND BACKGROUND OF THE INVENTION

It is common practice in connection with modern calf breeding to separate the calves from the cow and to keep the calves in a separate calf stall where they are bred by means of fresh milk, stored milk and/or milk substitute from a liquid feed supply device. Such a liquid feed supply device may comprise a nipple enabling the calves to receive liquid feed by suckling. Although the calves may not meet the cow of theirs during their breeding period, such breeding management has proved to be successful over the years. It is important to keep the calves in such a stall separated from a herd of a great number of cows in order to avoid injuries on the calves.

Many milk producers of today have a problem to adapt the production to an optimal quantity from a market point of view. Due to common production allocation rules, the milk producers may be given a relatively high price for the milk up to a certain milk quantity, or milk quota. When more milk is produced and delivered, the milk price decreases. In view of such decreasing milk price, milk producers frequently have surplus of milk. Hence, this milk surplus may be used for calf feeding.

Further, investigations show that calves fed with fresh milk are growing faster than those being fed with milk substitute or similar. Milk fed calves are believed to be healthier and such female calves may thus develop to better milk producers. Also, there are today ethical reasons for feeding calves with fresh milk.

Automatic milking of cows is disclosed in WO 96/19916 and WO 96/19917. It is known to perform such an automatic milking in a milking stall provided in a barn in which the animals are allowed to walk about freely and find their way individually to said milking stall, to feeding stalls and to drinking apparatus. The cows are automatically identified in each stall and fed with the aid of a computer connected to the identification and feeding means used. By means of the computer, in which facts concerning each cow, when she was last milked, etc. are stored, automatic milking is initiated. The milking stall also comprises gates, which are automatically closed to retain the cow during milking and opened to let the cow leave the milking stall.

Liquid feeding devices for calves comprise typically a milk supply device connected to one or several nipple means, which are arranged so as to enable calves to suck milk from the supply device. The supply of milk may be manually or automatically through some tubing and valve arrangement. Various liquid feeding devices are known in the art, see e.g. GB 2 162 735 A, DE 198 18 528 A1, U.S. Pat. Nos. 4,788,940, and 4,550,685.

It is known through to GB 2 162 735 A to take waste milk from a reservoir and process it in such a way, as to make it available for young animals to drink from a nipple, at the correct temperature.

U.S. Pat. No. 4,788,940 discloses a mechanism for feeding animals with liquid feed that can be withdrawn from a supply unit, such as an automatic soaking unit, and can be supplied to a suction unit via a conduit.

U.S. Pat. No. 4,550,685 discloses a device for supplying liquid feed from an automatic feeding device. The device comprises an animal operated discharge member or sucker that can be displaced into a plurality of different feeding stations in a controlled manner such that feed can be supplied accurately metered.

### SUMMARY OF THE INVENTION

However, none of these prior art feeding devices include any possibilities for automatic selection of the milk to be supplied.

Further, these feeding devices do not disclose any means for continous automatic supply of fresh milk in immediate connection with milking of milk producing animals, and in particular they do not disclose any means for animal selective supply of fresh milk.

Further, if supply of milk is to be performed manually, this is hard and uncomfortable work, which furthermore is time-consuming and thus costly in a long perspective.

Accordingly, it is an object of the present invention to provide a feed device, an arrangement and a method for automatic milk feeding of young animals, which are adapted to remedy the problems discussed above.

It is in this respect a particular object of the invention to provide such feed device, arrangement and method for milk feeding of young animals, which are highly automated.

It is a further object of the invention to provide a feed device, an arrangement and a method for milk feeding of young animals that facilitate monitoring and control by the dairy farmer.

It is yet a further object of the invention to provide a feed device, an arrangement and a method for automatic milk feeding of young animals, which are effective, flexible and of low cost.

It is still a further object of the invention to provide a feed device, an arrangement and a method for automatic milk feeding of young animals, which are accurate, precise, reliable, and safe.

It is yet further objects of the invention to provide a feed device and an arrangement for automatic milk feeding of young animals, which are easy and straightforward to install, and to provide a milk feeding method, which is effortless and simple to perform.

Hence, the present invention comprises the provision of a milk line connectable to at least one feed supply device and further connectable to a milking machine arranged for milking of a plurality of animals, particularly cows. Adaptation is provided such that the milk line can automatically transport milk from at least a selected one of the plurality of milk producing animals, particularly cows, to the feed supply device. The selected animal may be an animal, which is identified to produce milk of a predetermined quality, e.g. milk having high cell count values and/or which is unsuitable for refined dairy products or for human consumption. Also, a sick or injured animal or an animal producing beestings may be selected. Any selection may be performed on teat-individual basis.

Further, a feed device, an arrangement and a method for automatic milk feeding of young animals as claimed in the appended claims are provided in order to attain the above-mentioned objects.

An advantage of the present invention is that it provides for an effective overall operation of a milking farm, and a flexible and dynamic use of the milk produced.

The present invention provides for a more freely chosen working plan for the dairy farmer since the feeding (and some monitoring) may be performed automatically.

A further advantage of the present invention from a milk producing point of view is that if milk of high quality for human consumption, e.g. milk having very low cell count values, is separately collected, a better price can be obtained for this milk, and hence only lower quality milk is used for calf feeding.

Further characteristics of the invention and advantages thereof will be evident from the following detailed description of embodiments of the invention.

In the following detailed description the milk producing animals are cows and the young animals are calves. However, the invention is not limited to cows and their calves, but is applicable to any animals having the capability to produce large quantities of milk, such as sheep, goats, buffaloes, horses, etc.

### BRIEF DESCRIPTION OF THE DRAWINGS

The present invention will become more fully understood from the detailed description of embodiments of the present invention given hereinbelow and the accompanying FIGS. 1-3, which are given by way of illustration only, and thus are not limitative of the present invention.

FIG. 1 displays schematically an embodiment of an animal arrangement for housing a herd of animals including an automated system for milk feeding young animals.

FIG. 2 displays schematically a further embodiment of an animal arrangement for housing a herd of animals including an automated system for milk feeding young animals.

FIG. 3 displays schematically yet a further embodiment of an animal arrangement for housing a herd of animals including an automated system for milk feeding young animals.

### DETAILED DESCRIPTION OF EMBODIMENTS

In the following description, for purposes of explanation and not limitation, specific details are set forth, such as particular techniques and applications in order to provide a thorough understanding of the present invention however, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

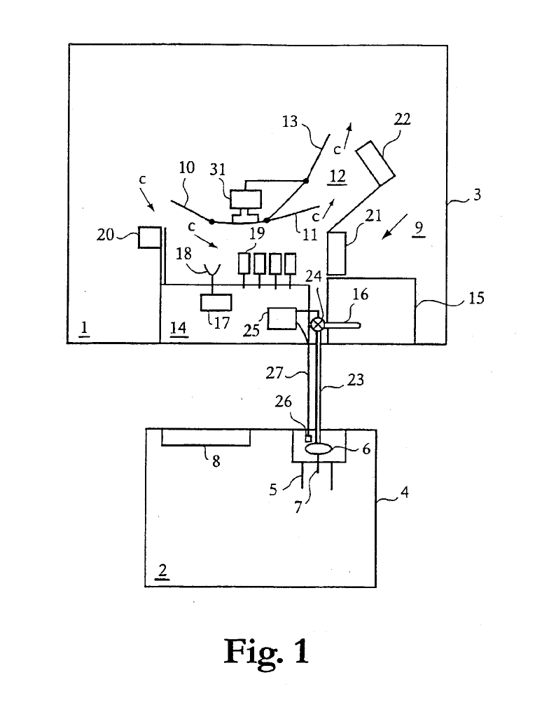

FIG. 1 discloses an animal arrangement for housing a herd of animals including cows and calves. The arrangement comprises a first area 1 and a second area 2. The first area 1 is defined by first enclosure means 3 in the shape of a fence, a grid or the like, and the second area 2 is defined by a second enclosure means 4 in the shape of a further fence, a grid or the like. In the embodiment disclosed the second area 2 is completely arranged outside the first area 1; however, it is possible in accordance with the present invention to arrange the second area 2 within the first enclosure means 3 defining the first area 1. The first area 1 is arranged to house cows permitted to walk about freely in the first area 1. The second area 2 is arranged to house calves permitted to walk about freely in the second area 2.

In the second area 2, there is provided a liquid feed stall accessible to the calves. The stall 5 comprises a liquid feed supply device 6 arranged to offer liquid feed such as fresh milk to the calves. The liquid feed supply device 6 comprises a nipple member, schematically indicated at 7, which enables sucking of said liquid feed by the calves. The second area 2 may also comprise a feeding device 8 arranged to offer solid feed, such as concentrate and hay.

In the first area 1, there is provided a milking station 9 provided for voluntary milking of the freely walking cows, i.e. the cows enter the milking station 9 in order to be milked when they need to. The milking station 9 comprises an enclosure having an inlet gate 10 and an outlet gate 11. Outside the outlet gate 11 there may be an exit space 12 to be passed by the cow leaving the milking station. The exit space 12 comprises a further outlet gate 13.

The milking station 9 comprises a milking machine 14 connected to a milk storage tank 15 by means of a milk line 16. Milking machine 14 includes an automatic handling device 17 having a robot arm 18 arranged to automatically apply teatcups 19 of the milking machine to the teats of a cow present in the milking station 9.

Furthermore, the milking station 9 may comprise an identification member 20 provided to identify a cow approaching the milking station 9. All of the gates 10, 11 and 13 are controllable by means of a schematically disclosed gate control device 31.

Thus a cow approaching the milking station may be given access to the milking station after having been identified by the identification member 20 by opening of the inlet gate 10.

During milking, milk is drawn from the teats of the cow by means of vacuum being applied to the teatcups 19. The milk drawn is measured by means of one or several milk meters (not illustrated), whereafter it is collected in milk storage tank 15. Preferably, there is provided a milk meter for each teat for measuring the individual milk flow from each teat.

After the milking has been completed the cow may leave the milking station 9 by opening of the outlet gates 11 and 13. The milking station 9 may also comprise a first feeding device 21 provided in the front end of the milking station 9 and a second feeding device 22 provided in the front end of the exit space 12.

A purpose of the first feeding device 21 is to entice the cow to enter the milking station 9 and to make her stand still during at least the attachment of the teatcups and a purpose of the second feeding device 22 is to entice the cow to leave the milking station 9 after the milking has been finished or is interrupted for any reason.

It is to be noted that the cow may be enticed to enter and leave the milking station 9 by other enticing means than the feeding devices 21, 22 disclosed. In this connection reference is made to the above-identified WO 96/19917. Furthermore, it is to be noted that the first area 1 also may include separate feeding and liquid supply boxes as well as more than one single milking station 9.

According to the present invention a milk line 23 is provided to permit transport of milk from milking machine 14 to liquid feed supply device 6 in the second area 2.

Milk lines 23 and 16 are connected to the milk machine by means of a three way valve 24 such that milk being collected in the milking machine is either transported to the milk storage tank 15 or to the liquid feed device 6. Valve 24 is controllable by means of a milk flow control device 25, which is supplied with a signal from identification member 20, said signal identifying each cow entering milking station 9.

The milking machine comprises further valve and line arrangements (not illustrated) in order to provide for discharge of waste milk and cleaning liquid. Particularly, as an alternative to three way valve 24, a four way valve may be used having also a waste discharge line connected thereto.

By such an arrangement it is possible to automatically transport milk from a selected one of a plurality of cows from the milking machine 14 to the feed device 6.

Particularly, milk from a cow being identified to produce milk of a predetermined quality is selected to be fed through line 23 to feed device 6, instead of the customary feed to storage tank 15. The milk of the predetermined quality may be chosen as milk, which is unsuitable for human consumption, e.g. if the cow is sick or injured, the milk may have high cell count values or there may be blood in the milk.

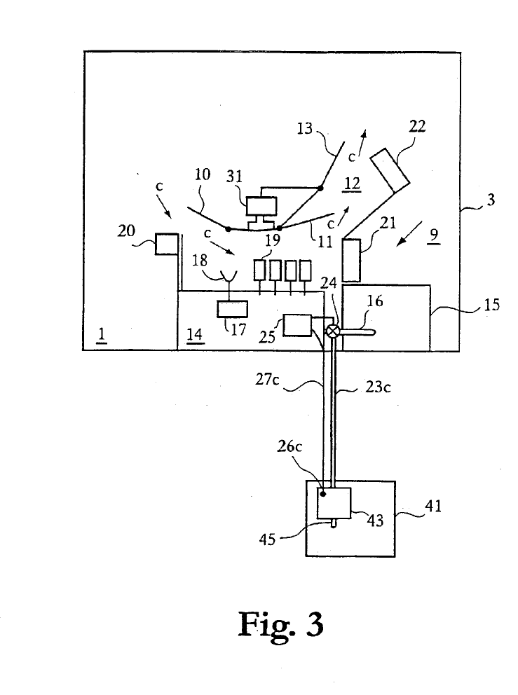

An other alternative is to choose milk from a cow being identified as one that has recently given birth to a calf. This aspect of the invention is further elaborated below with reference to FIG. 3. Yet an other alternative is to choose milk from a cow being identified at a given predetermined time, e.g. at a certain time in the morning or subsequent to regular cleaning of milk lines.

It shall be appreciated that the milk from each teat can be treated, i.e. measured, analyzed and transported, individually in the present milking station and hence the present invention include the possibility of automatically transporting milk from not only a selected one of a plurality of cows, but also from a selected one of the teats of said cow, from the milking machine 14 to the feed device 6. Thus, the invention provides for teat-individual selection of milk for calf feeding.

As the milking performed is a voluntary milking of the freely walking cows it may happen that the milk in feed device 6 is consumed before any selected cow enters milking station 9, and hence feed device 6 is completely emptied.

In order to remedy such a problem there is provided a level sensor 26 for measuring the level of the milk in liquid feed device 6 and thus the amount of milk left in feed device 6. This measured level is transferred through a control line 27 back to milk flow control device 25. Thus the selected cow, from which milk is automatically fed to feed device 6, may be chosen in dependence on said measured level of milk in feed device 6. Preferably, the selected cow is determined to be the next cow to be milked if the indicated level of milk is below a lower predetermined level, a so-called low-water mark.

Further, two subsequent readings yield the milk consumption at feed device 6 and by measuring the time between the readings the milk consumption rate may be estimated. These values may be used in the control of the milk supply according to the present invention, and further, the values may be stored in a database, and used for other purposes.

By providing the liquid feed stall 5 with a calf identification member (not illustrated) adapted to identify a calf entering the stall a calf may be given access to feed device 6 after having been identified by the calf identification member.

The combined provision of a level sensor and a calf identification member provide for individual monitoring and controlling of the feeding of each calf.

The amount of milk supplied to feed device 6 each time may be predetermined or may be in dependence on the level indicator 26 indicating that the level of milk is exceeding a higher predetermined level, a so-called high-water mark.

Further, the feed device may comprise cleaning means for cleaning milk-contacting surfaces of feed device 6 e.g. on a regular time basis.

Preferably, oxygen is added to the milk supplied to the calf feed device so as to preserve the milk.

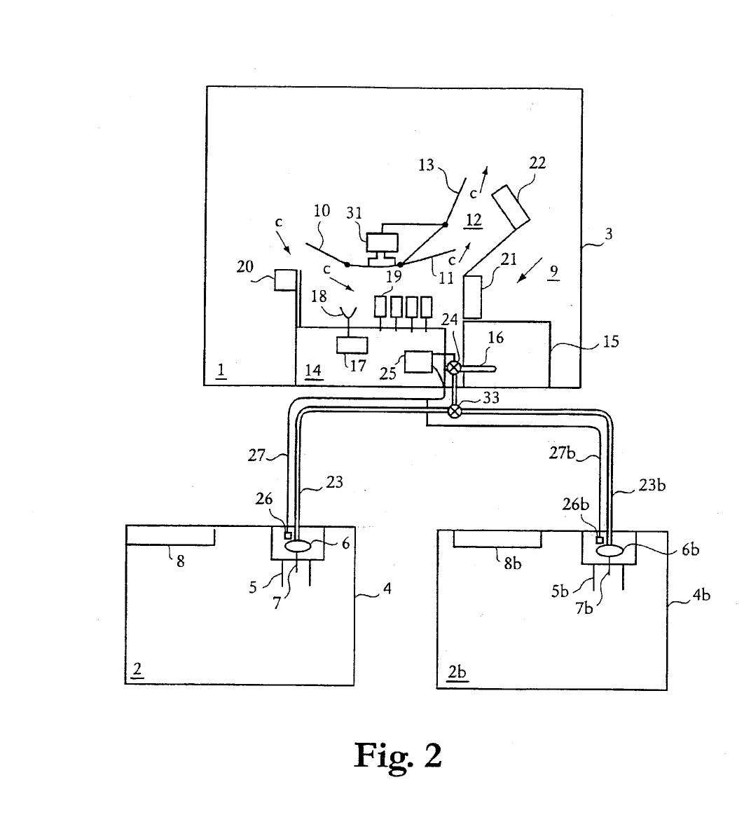

Next, with reference to FIG. 2, which schematically displays a further animal arrangement for housing a herd of animals including an automated system for milk feeding young animals, a second embodiment of the present invention will be described.

This embodiment includes the arrangement of FIG. 1 and further a third area 2b defined by third enclosure means 3b in the shape of a fence or similar. The third area 2b is arranged to house calves permitted to walk about freely in the third area 2b.

In the third area 2b, there is provided a feed stall 5b accessible to the calves in the third area. The stall 5b comprises a liquid feed supply device 6b arranged to offer liquid feed to calves. Further, the supply device 6b comprises a nipple member 7b, for enabling sucking of the liquid feed by calves. The third area 2b may comprise a feeding device 8b arranged to offer solid feed.

In this embodiment, a three way valve 33 is arranged in the milk line 23 downstream of three way valve 24. A further milk line 23b is connected between three way valve 33 and the feed supply device 6b in the third area so as to permit transport of milk from the milking machine 14 to feed supply device 6b. Valve 33 is controllable by means of the milk flow control device. Alternatively, instead of using the three way valves 24 and 33 a four way valve, or other suitable switching means, may be used.

Furthermore, also feed stall 5b is provided with a level sensor 26b for sensing the level of milk in feed supply device 6b, and a feedback line 27b is provided for transferring the sensed level of milk back to milk flow control device 25.

By such an arrangement it is possible to automatically transport milk from a selected one of a plurality of cows from the milking machine 14 to the feed device 6 and to automatically transport milk from a second selected one of a plurality of cows from the milking machine i4 to the feed device 6b.

The calves arranged to be housed in the third area 2b may be calves of a different age than those arranged to be housed in the second area 2. Alternatively, the calves in the third area are distinguishable from those in the second area in other manner, e.g. through their breed, health, size, or sex.

Finally, with reference to FIG. 3, which schematically displays yet a further animal arrangement for housing a herd of animals including an automated system for milk feeding young animals, a third embodiment of the invention will briefly be described.

This embodiment includes the first area 1, provided with the milking station 9 as shown in FIG. 1 and further a fourth area or stall 41. The fourth area 41 is arranged to house a single recently born calf and comprises a feed device suitable for feeding of recently born calves, here in the form of a bucket 43 or similar provided with a nipple 45, which enables sucking of milk from bucket 43.

The first days of the life of a calf is housed isolated from other animals and it is, during the first few days, fed with beestings from a cow more or less manually, e.g. by holding bucket 43 and monitoring the suckling by the calf. Such beestings are fat, contains high levels of antibodies and shall not be mixed with milk from other cows.

According to the invention a milk line 23c is connected to the milking machine 14 in the first area 1 through three way valve 24, and to the bucket 43 in the fourth area 41 so as to permit transport of milk (including beestings) from the milking machine 14 to bucket 43.

By such an arrangement it is possible to automatically transport milk from a selected one of a plurality of cows from the milking machine 14 to the bucket 43. Preferably, the selected cow is 2 cow, which recently has given birth to a calf (but not necessarily the calf housed in the fourth area 41), and thus produces beestings.

Furthermore, also bucket 43 may be provided with a level sensor 26c for sensing the level of milk in bucket 43, and a feedback line 27c is provided for transferring the sensed level of milk back to milk flow control device 25.

If the milk line 23c and the bucket 43 have been used for supply of beestings, they (as well as the milking machine) shall preferably be cleaned before a cow producing ordinary milk is allowed to enter the milking station.

By the arrangements according to the present invention possibilities of automatic breeding of calves by milk from individually selected cows via liquid feed supply devices, such as 6, 6b and 43, through an automatic milk supply arrangement have-been demonstrated.

It shall be appreciated that the present invention is usable with other milking machines than the one described above. Particularly, it is usable with rotary or Herringbone parlours. Preferably, in such instances, milk is transported to the feed device two or three times a day, and only from cows with milk having high cell count values.

It shall further be appreciated that the arrangement of the present invention may comprise a third and a further feed device connected to the milking machine by means of further milk lines (not illustrated) and that a single feed device may be supplied with milk from a plurality of different milking machines.

It shall also be appreciated that the farmer nevertheless manually observes the calves and ensures that they are fed on regular time basis.

It will be obvious that the invention may be varied in a plurality of ways. Such variations are not to be regarded as a departure from the scope of the invention. All such modifications as would be obvious to one skilled in the art are intended to be included within the scope of the appended claims.

1. A feed apparatus for automatic milk feeding of young animals comprising a feed supply device (6, 6b, 43), characterized i n that it comprises a milk line (23, 23b, 23c) connectable to said feed supply device and further connectable to a milking machine (14) arranged for milking a plurality of animals, wherein said milk line is adapted to automatically transport milk from at least a selected one of said plurality of milk producing animals to said feed supply device.

2. The feed apparatus as claimed in claim 1, wherein said milk line is adapted to automatically transport milk from at least one selected teat of a selected one of said plurality of milk producing animals to said feed supply device.

3. The feed apparatus as claimed in claim 1 or 2, wherein said feed supply device is provided with a nipple member (7, 7b, 45) for enabling sucking of said milk automatically transported to the feed supply device by said young animals.

4. The feed apparatus as claimed in any of claims 1-3, wherein said milk line (23, 23b, 23c) is connectable to said milking machine (14) by means of a valve (24, 33).

5. The feed apparatus as claimed in any of claims 1-3, wherein said selected one of said plurality of milk producing animals, from which milk is automatically transported to said feed supply device, is an animal being identified to produce milk of a predetermined quality.

6. The feed apparatus as claimed in claim 5, wherein said milk of said predetermined quality is milk, which is unsuitable in refined dairy products.

7. The feed apparatus as claimed in claim 5, wherein said milk of said predetermined quality is milk, which is unsuitable for human consumption.

8. The feed apparatus as claimed in claim 5, wherein said animal, which is identified to produce milk of said predetermined quality, is a sick or injured animal.

9. The feed apparatus as claimed in claim 5, wherein said animal, which is identified to produce milk of said predetermined quality, is an animal known to produce milk having high cell count values.

10. The feed apparatus as claimed in any of claims 1-4, wherein said selected one of said plurality of milk producing animals, from which milk is automatically transported to said feed supply device, is an animal being identified as one that has recently given birth to an animal and thus produces beestings.

11. The feed apparatus as claimed in any of claims 1-4, wherein said selected one of said plurality of milk producing animals, from which milk is automatically transported to said feed supply device, is an animal being identified at a predetermined time.

12. The feed apparatus as claimed in any of claims 1-11, wherein said feed supply device (6) is provided with a level indicator (26, 26b, 26c) for indicating the level of milk in said feed supply device and wherein said selected one of said plurality of milk producing animals, from which milk is automatically transported to said feed supply device, is selected in dependence on said indicated level of milk.

13. The feed apparatus as claimed in claim 12, wherein said selected one of said plurality of milk producing animals, from which milk is automatically transported to said feed supply device, is the first animal to be milked by said milking machine (14) subsequent to said indicated level of milk falling below a low-water mark.

14. The feed apparatus as claimed in any of claims 1-11, wherein said feed supply device (43) is adapted for feeding a recently born calf.

15. The feed apparatus as claimed in any of claims 1-11, wherein said feed supply device comprises a bucket (43) provided with a nipple member (45).

16. The feed apparatus as claimed in any of claims 1-15, wherein it further comprises a second feed supply device (6b), and a second milk line (23b) connectable to said second feed supply device and further connectable to the milking machine (14), wherein said second milk line is adapted to automatically transport milk from at least a second selected one of said plurality of milk producing animals to said second feed supply device.

17. An arrangement for automatic milk feeding of young animals comprising an automatic milking machine (14) for milking of a plurality of milk producing animals and a milk storage tank (15) connectable to said milking machine and arranged for collecting of milk from said plurality of milk producing animals, characterized b y a feed device (6, 6b, 43) connectable to said milking machine by way of a milk line (23, 23b, 23c) and adapted to collect milk from at least a selected one of said plurality of milk producing animals.

18. The arrangement as claimed in claim 17, wherein said selected one of said plurality of milk producing animals, from which milk is automatically collected by said feed device, is an animal being identified to produce milk of a predetermined quality.

19. The arrangement as claimed in claim 18, wherein said milk of said predetermined quality is milk, which is unsuitable in refined dairy products.

20. The arrangement as claimed in claim 18, wherein said milk of said predetermined quality is milk, which is unsuitable for human consumption.

21. The arrangement as claimed in claim 17, wherein said selected one of said plurality of milk producing animals, from which milk is automatically collected by said feed device, is an animal being identified as one that has recently given birth to an animal and thus produces beestings.

22. The arrangement as claimed in claim 17, wherein said feed supply device (43) is adapted for feeding a recently born calf.

23. The arrangement as claimed in claim 17, wherein said selected one of said plurality of milk producing animals, from which milk is automatically collected by said feed device, is an animal being identified at a predetermined time.

24. The arrangement as claimed in any of claims 17-23, wherein said feed device (6, 6b, 43) is provided with a level indicator (26, 26b, 26c) for indicating the level of milk in said feed device and wherein said selected one of said plurality of milk producing animals, from which milk is automatically collected by said feed device, is selected in dependence on the indication of said level indicator.

25. A method for automatic milk feeding of young animals at a feed device (6, 6b, 43) comprising the steps of:
automatically milking a plurality of milk producing animals by means of an automatic milking machine (14); and
automatically collecting milk from said plurality of milk producing animals in a milk storage tank (15) being connectable to said milking machine,
characterized by
automatically collecting milk from at least a selected one of said plurality of milk producing animals in said feed device by means of a milk line (23, 23b, 23c) being connectable between said milking machine and said feed device.

26. The method as claimed in claim 25, wherein said selected one of said plurality of milk producing animals, from which milk is automatically collected in said feed device, is chosen as an animal being identified to produce milk of a predetermined quality.

27. The method as claimed in claim 26, wherein said milk of said predetermined quality is milk, which is unsuitable in refined dairy products.

28. The method as claimed in claim 26, wherein said milk of said predetermined quality is milk, which is unsuitable for human consumption.

29. The method as claimed in claim 26, wherein said milk of said predetermined quality is milk having high cell count values.

30. The method as claimed in claim 25, wherein said selected one of said plurality of milk producing animals, from which milk is automatically collected in said feed device, is chosen as an animal being identified as one that has recently given birth to an animal and thus produces beestings.

31. The method as claimed in any of claims 25-30, further comprising the steps of:
indicating the level of milk in said feed device (6, 6b, 43) by means of a level indicator (26, 26b, 26c), and
choosing said selected one of said plurality of milk producing animals from which milk is automatically collected in said feed device, in dependence on said indicated level of milk.

32. The method as claimed in claim 31, wherein said selected one of said plurality of milk producing animals, from which milk is automatically collected in said feed device, is chosen as the first animal to be milked by said milking machine when said level indicator indicating a level below a low-water mark.
